(19) United States
(12) Patent Application Publication
(10) Pub. No.: US 2001/0009174 A1
(43) Pub. Date: Jul. 26, 2001

(54) INKJET RECEPTOR LAYERS ON SUBSTRATES AND METHODS FOR TRANSFERRING SUCH LAYERS TO SUCH SUBSTRATES

(76) Inventors: DUANE W DINKEL, AUSTIN, TX (US); DAVID WARNER, MAPLEWOOD, MN (US)

Correspondence Address: JOHN H HORNICKEL, 3M OFFICE OF INTELLECTUAL PROP COUNSEL, P O BOX 33427, ST PAUL, MN, 551333427

(21) Appl. No.: 09/112,671

(22) Filed: Jul. 9, 1998

(51) Int. Cl. B44C 1/00

(52) U.S. Cl. 156/238; 156/230; 156/239; 156/240; 427/146

(57) ABSTRACT

This invention discloses ink jet receptor coatings and processing conditions to provide a transferable receptor with controlled gloss properties to a receiving substrate. Image graphics produced under these conditions are significantly and unexpectedly improved with minimal coalescence of and “mudcracking” of ink jet images. The ink jet receptor on a temporary carrier web has one or more layers where one layer is a top-surface-providing layer that is weakly bonded to a temporary carrier web. The top-surface-providing layer becomes the exposed surface on a receiving substrate.

### FIELD OF INVENTION

This invention relates to coatings for use as receptor surfaces for image graphics, adhesive surfaces for substrates, and conformable surfaces for substrates.

### BACKGROUND OF INVENTION

Image graphics are omnipresent in modern life. Images and data that warn, educate, entertain, advertise, etc. are applied on a variety of interior and exterior, vertical and horizontal surfaces. Nonlimiting examples of image graphics range from advertisements on walls or sides of trucks, posters that advertise the arrival of a new movie, warning signs near the edges of stairways.

The use of thermal and piezo ink jet inks have greatly increased in recent years with accelerated development of inexpensive and efficient ink jet printers, ink delivery systems, and the like.

Thermal ink jet hardware is commercially available from a number of multinational companies, including without limitation, Hewlett-Packard Corporation of Palo Alto, Calif., USA; Encad Corporation of San Diego, Calif., USA; Xerox Corporation of Rochester, N.Y., USA; LaserMaster Corporation of Eden Prairie, Minn., USA; and Mimaki Engineering Co., Ltd. of Tokyo, Japan. The number and variety of printers changes rapidly as printer makers are constantly improving their products for consumers. Printers are made both in desk-top size and wide format size depending on the size of the finished image graphic desired. Nonlimiting examples of popular commercial scale thermal ink jet printers are Encad's NovaJet Pro printers and H-P's 650C and 750C printers. Nonlimiting examples of popular desk-top thermal ink jet printers include H-P's DeskJet printers.

3M markets Graphic Maker Ink Jet software useful in converting digital images from the Internet, ClipArt, or Digital Camera sources into signals to thermal ink jet printers to print such images.

Ink jet inks are also commercially available from a number of multinational companies, particularly 3M which markets its Series 8551; 8552; 8553; and 8554 pigmented ink jet inks. The use of four principal colors: cyan, magenta, yellow, and black permit the formation of as many as 256 colors or more in the digital image.

Media for ink jet printers are also undergoing accelerated development. Because ink jet imaging techniques have become vastly popular in commercial and consumer applications, the ability to use a personal computer to print a color image on paper or other receptor media has extended from dye-based inks to pigment-based inks. And the media must accommodate that change. Pigment-based inks provide more brilliant colors and more durable images because pigment particles are contained in a dispersion before being dispensed using a thermal inkjet print head.

Ink jet printers have come into general use for wide-format electronic printing for applications such as, engineering and architectural drawings. Because of the simplicity of operation and economy of ink jet printers, this image process holds a superior growth potential promise for the printing industry to produce wide format, image on demand, presentation quality graphics.

The components of an ink jet system used for making graphics can be grouped into three major categories:

1 Computer, software, printer.

2 Ink.

3 Receptor medium.

The computer, software, and printer will control the size, number and placement of the ink droplets and will transport the receptor medium through the printer. The ink will contain the colorant or pigments which form the image and the receptor medium provides the medium which accepts and holds the ink. The quality of the ink jet image is a function of the total system. However, the composition and interaction between the ink and receptor medium is most important in an ink jet system.

Image quality is what the viewing public and paying customers will want and demand to see. From the producer of the image graphic, many other obscure demands are also placed on the ink jet media/ink system from the print shop. Also, exposure to the environment can place additional demands on the media and ink (depending on the application of the graphic).

Current ink jet receptor media are direct coated with a dual layer receptor according to the disclosure contained in U.S. Pat. No. 5,747,148 (Warner et al.) and are marketed by 3M-Commercial Graphics Division under the brand 3M Thermal Ink Jet. Process conditions and receptor formulations are unique to the particular film surface for which the coatings are applied. Slight incompatibilities between the solution and film surface energies often results in surface irregularities such as non-wets, ribbing patterns, and gloss inconsistencies when the image is applied to the graphic.

Material-specific processing also eliminates the manufacturing advantages associated with high speed, high volume production. Multilayered receiving substrates or other backings (i.e.,. liner/adhesive/film constructions) can present additional manufacturing challenges due to potential limitations in the mechanical and heat resistance properties of an individual layer vis-a-vis other layers in the laminate. Furthermore, the unique receptor formulations and coated rollstocks create inventory issues for manufacturers and their customers because each of the many ink jet receptor media is a unique construction.

### SUMMARY OF INVENTION

What the art needs is a coating that provides all of the advantages of excellent performing ink jet receptors without the limitations of being constructed with a single receiving substrate.

What the art also needs is a coating that can be processed on to a variety of acceptable receiving substrates under economical and efficient conditions.

One aspect of the invention is an ink jet receptor on a temporary carrier web comprising: one or more layers where one layer is a top-surface-providing layer weakly bonded to the temporary carrier web. Preferably, the receptor has a a bottom-surface-providing layer contacting the top-surface-providing layer.

“Temporary” means that the carrier web is not intended for use as a receiver of inkjet images. As will become apparent below, even if the temporary carrier web did receive an image, the location of image reception would be on a layer which is intentionally inverted from its location for final, proper inkjet imaging. In other words, the top-surface-providing layer is intended to be transferred from the temporary carrier web to a receiving substrate before imaging.

The top-surface-providing layer enhances absorption of water from an ink jet droplet whereas the bottom-surface-providing layer absorbs water rapidly from an ink droplet placed onto the top-surface-providing layer, minimizes dye or pigment particle migration, and acts as an adhesive when heat bonded to a receiving substrate surface.

Another aspect of the invention is a method for making an ink jet receptor media comprising the steps of (a) coating a top-surface-providing layer onto a temporary carrier web to form a layer or laminate of layers having a bottom surface and a top surface; (b) contacting the bottom surface of the layer to a receiving substrate; and (c) removing the temporary carrier web to reveal an ink jet ink receptor layer on the receiving substrate with the top surface of the layer as an exposed surface on the receiving substrate.

The inkjet receptor layer formed on the receiving substrate can have no other layers, one other layer, or multiple other layers between it and the receiving substrate. Therefore, reference to “bottom surface” also means the bottom-most surface of the last of the layers in a laminate of more than one layer. Likewise, reference to “top-surface” also means the top-most surface of the first of the layers in a laminate of more than one layer.

Moreover, if not otherwise apparent, reference to “bottom surface” and “top surface” is provided with reference to orientation on the receiving substrate, not the temporary carrier web.

Preferably the contacting step uses heat, pressure, an activation fluid, or a combination of them to assist in complete transfer of the receptor layer(s) bottom-surface-providingtop-surface-providingto the receiving substrate.

A feature of the present invention is the ability to provide just-in-time manufacturing of ink receptor coatings on a variety of commercial stock substrates according to the needs of the manufacturer and its customers.

Another feature of the invention is the ability to use a single type of temporary carrier web for one step of manufacture and a myriad of receiving substrates for ink jet media purposes.

An advantage of the present invention is manufacturing economy and production efficiency with better inventory control and working capital usage without a diminishment of ink jet receptor performance for the image graphic.

Another advantage of the present invention is that the surface of the temporary carrier web adjacent to the coating or “top-surface-providing” layer can be used to control the surface finish of the transferred coating and therefore the unprinted media and the finished graphic; e.g. if the carrier has a high degree of gloss then the glossy surface is imparted to the finished article after transferring the coating to the receiving substrate, or if a special finish is desired, a structured or rough surface then this could also be imparted to the finished article.

Further features and advantages appear in the discussion of embodiments of the invention in relation to the following drawing.

### BRIEF DESCRIPTION OF DRAWINGS

FIG. 1 is a cross-sectional view of a two layer receptor coating of the present invention residing on a temporary carrier web after manufacture and before use.

FIG. 2 is a cross-sectional view of a two layer receptor coating of the present invention residing on a receiving substrate ready for ink jet printing.

### EMBODIMENTS OF INVENTION

The inkjet receptor of the present invention can be a laminate of two or more layers or a single layer. While the embodiments refer mostly to two layers, it is to be understood that the properties of both layers could become combined into one layer or further separated into a greater number of layers to create differentiation and flux in properties among the various layers. In other words, the inkjet receptor needs a bottom surface and a top surface, which can be supplied by a single layer, two different layers, and a variety of multiple layers where the properties of the intermediate layers are not important to adhesion to the receiving substrate (satisfied by the properties of the bottom surface) or to the inkjet reception (satisfied by the properties of the top surface).

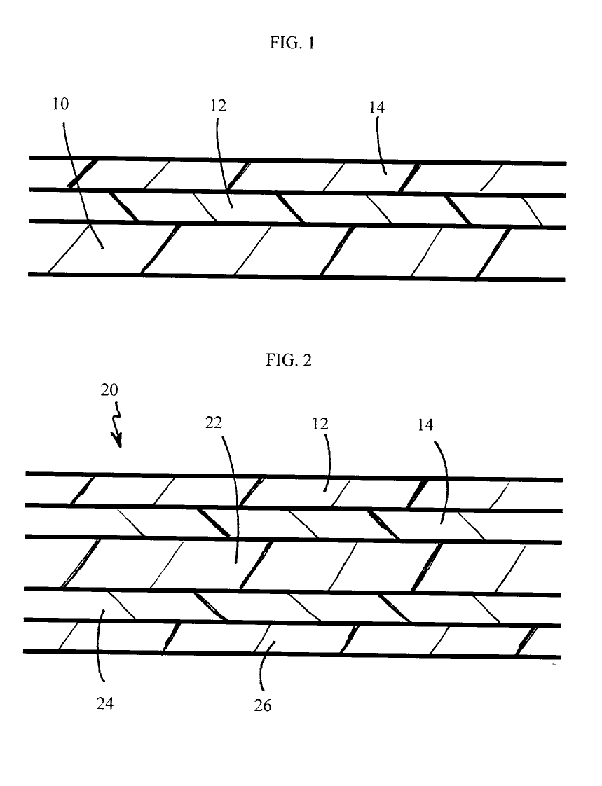

FIG. 1 shows a cross-sectional view of a temporary carrier web 10 having a top- surface-providing layer 12 and a bottom-surface-providing layer 14 coating thereon in that order.

Temporary Carrier Web

Any conventional temporary carrier web can be used for temporarily receiving the top-surface-providing layer and bottom-surface-providing layer. Nonlimiting examples of such temporary carrier webs include coated (alkyd and acrylic) and uncoated paper liners, paper laminates and plastic films (e.g. polyester, polypropylene, etc). In the temporary carrier web construction, the topmost layer (at the air interface) which comes in contact with the receiving substrate should adhere to the receiving substrate better than the layer directly adjacent to the temporary carrier web under the conditions of transfer. e.g. For a two layer receptor coating, under the conditions of the transfer the bottom-surface-providing layer adheres to the receiving substrate and the top-surface-providing layer releases from the temporary carrier web. This can be achieved by having two or more layers where the top-surface-providing layer releases easily from the temporary carrier web, and the bottom-surface-providing layer adheres to the receiving substrate. However, the difference in adhesion could also be achieved by other means. For example, the receptor coating could be coated onto a temporary carrier web with a release surface. Then it is possible to transfer a single layer receptor coating because the receptor coating would adhere to the receiving substrate better than the release surface of the temporary carrier web under the conditions of the transfer. The backside of the temporary carrier web (the side opposite from the surface with the receptor coating) could also have a release layer to prevent transfer of the receptor coating from the carrier frontside to the backside when the coated temporary carrier web is stored in roll form.

Methods can also be employed to increase the adhesion of the bottom-surface-providing layer of the ink jet receptor coating to the receiving substrate. A preferred method is to corona treat the receiving substrate, preferably a short time (within a few days) before transferring the coating from the temporary carrier web to the receiving substrate.

For purposes of manufacturing and handling, the temporary carrier web 10 can have a thickness of from about 0.01 to about 0.75 and preferably from about 0.05 to about 0.15 mm.

For purposes of assuring good release of top-surface-providing layer 12 from the temporary carrier web at the time of transfer to a receiving substrate, the temporary carrier web 10 has a surface such that the adhesion between it and the layer or top-surface-providing layer under the conditions of transfer is between 0 lb/in (0 N/m) and the cohesive strength or the force required for elongation of the receptor, which in many cases will be less than 5 lb/in (about 900 N/m). The critical surface tension of the receiving substrate shall be 20-60 dynes/cm, although this will be heavily dependent on the particular receptor chemistry.

There is no limit to the area of temporary carrier web 10 useful for manufacturing but practicality intervenes for use involving transfer to a receiving substrate. The width of the temporary carrier web can range from about 2 cm to about 2 m and preferably from about 30 cm to about 1.5 m.

For purposes of providing a resulting exposed surface of top-surface-providing layer on receiving substrate having a gloss from about 5 to about 100, the surface gloss of the temporary carrier web 10 can range from 20 to about 40 for matte applications and from about 60 to about 80 for luster applications.

Top-Surface-Providing Layer

Top-surface-providing layer 12 can be any composition providing it can release from the temporary carrier web 10 under at least one set of conditions of temperature, pressure and web speed onto receiving substrate. Nonlimiting examples of compositions include those disclosed in U.S. Pat. Nos. 4,379,804 (Eisele et al.); 4,935,307 (Iqbal et al.); 5,045,391 (Brandt et al.); 5,108,865 (Zwaldo et al.); 5,208,092 (Iqbal); 5,342,688 (Kitchin et al.); 5,389,723 (Iqbal et al.); and 5,747,148 (Warner et al.), the disclosures of which are incorporated by reference herein. Preferably, the top-surface-providing layer is any of the compositions called a protective penetrant layer in U.S. Pat. No. 5,747,148 (Warner et al.). Nonlimiting examples of such compositions include poly(vinyl pyrrolidone), copolymers of vinyl pyrrolidone e.g. with ethylene or styrene, poly(vinyl alcohol), polyacrylic acids, polymethacrylic acids or (1-alkyl) acrylic acid copolymers and the inorganic salts such as alkali metal salts derived therefrom, poly(alkylene oxides) or polyglycols, carbohydrates, alkyl and hydroxylalkyl cellulose derivatives, starch and starch derivatives such as hydroxyalkyl starches, carboxyalkyl celluloses and their salts, gum arabic, xanthan gum, carageenan gum, proteins and polypeptides.

The top-surface-providinglayer can include dispersed particles or particulates according to the disclosure of U.S. Pat. No. 5,747,148 (Warner et al.). Nonlimiting examples of such dispersed particles or particulates include corn starch or modified corn starches, silica, alumina, titanium dioxide or other white inorganic oxide or hydroxide materials, cotton or flock particles and other cellulose or modified cellulose particulates, calcium carbonate or calcium silicate and other white inorganic silicates, sulfides and carbonates, clays, and talc. The size of the dispersed particles or particulates are typically in the range of approximately 1 to 40 micrometers in diameter, preferably in the range of approximately 2 to 20 micrometers in diameter. However, it is not intended that the invention be limited to this range, provided there are sufficient particles have sizes large enough to roughen the top surface. The enumerated size distribution is a typical range, although it permissible to use particles or particulates that are outside the above-stated range of sizes. Particles and/or particulates and are added into solution for the top-surface-providing layer in the range of 10 to 60% by weight of total solids, preferably in the range of 15 to 25% by weight of total solids. Furthermore, dispersed particles and particulates are generally available in a distribution of sizes, although it is not intended to foreclose the use of a single sized particle or particulate, provided the size is large enough as described above.

Preferred dried top-surface-providing layer coating weights are in the range of about 0.05 to about 2 g/m² (approximately five to 200 milligrams per square foot). Assuming densities of 1 g/cm³, this gives preferred thicknesses of the top-surface-providing layer of 0.05 to 2 μm approximately. Polymer densities can vary between 0.8 and 2.7 grams per cubic centimeter. For example poly(vinyl alcohol) has a density range of 1.27 to 1.490 (Polymer Handbook, 3^{rd} Edition, J. Brandrup and E. H. Immergut, Wiley-Interscience publication of John Wiley and Sons). The preferred average particle sizes are 2 to 20 μm in diameter thus exceeding the approximate preferred thickness range of the dried top-surface-providing layer. The average particle diameter of a preferred particulate, cornstarch, is approximately 20 μm, thus far exceeding the range of top-surface-providing layer thicknesses possible from the preferred range of coating weights.

Bottom-Surface-Providing Layer

Bottom-surface-providing layer 14 can be any composition providing it can adhere to a receiving substrate under at least one set of conditions of temperature, pressure and web speed onto receiving substrate. Nonlimiting examples of compositions include those disclosed in U.S. Pat. Nos. 4,379,804 (Eisele et al.); 4,935,307 (Iqbal et al.); 5,045,391 (Brandt et al.); 5,108,865 (Zwaldo et al.); 5,208,092 (Iqbal); 5,342,688 (Kitchin et al.); 5,389,723 (Iqbal et al.); and 5,747,148 (Warner et al.), the disclosures of which are incorporated by reference herein. Preferably, the top-surface-providing layer is any of the compositions called an ink jet receptor layer in U.S. Pat. No. 5,747,148 (Warner et al.). Nonlimiting examples of such compositions include poly(vinyl pyrrolidone), copolymers of vinyl pyrrolidone e.g. with ethylene or styrene, poly(vinyl alcohol), polyacrylic acids, polymethacrylic acids or (1-alkyl) acrylic acid copolymers and the inorganic salts such as alkali metal salts derived therefrom, poly(alkylene oxides) or polyglycols, carbohydrates, alkyl and hydroxylalkyl cellulose derivatives, starch and starch derivatives such as hydroxyalkyl starches, carboxyalkyl celluloses and their salts, gum arabic, xanthan gum, carageenan gum, proteins and polypeptides.

The bottom-surface-providing layer can include dispersed particles or particulates according to the disclosure of U.S. Pat. No. 5,747,148 (Warner et al.). Nonlimiting examples of such dispersed particles or particulates include corn starch or modified corn starches, silica, alumina, titanium dioxide or other white inorganic oxide or hydroxide materials, cotton or flock particles and other cellulose or modified cellulose particulates, calcium carbonate or calcium silicate and other white inorganic silicates, sulfides and carbonates, clays, and talc. The size of the dispersed particles or particulates are typically in the range of approximately 1 to 40 micrometers in diameter, preferably in the range of approximately 2 to 20 micrometers in diameter. However, it is not intended that the invention be limited to this range, provided there are sufficient particles have sizes large enough to roughen the upper surface of the bottom-surface-providing layer. The enumerated size distribution is a typical range, although it permissible to use particles or particulates that are outside the above-stated range of sizes. Particles and/or particulates and are added into solution for the top-surface-providing layer in the range of 10 to 60% by weight of total solids, preferably in the range of 15 to 25% by weight of total solids. Furthermore, dispersed particles and particulates are generally available in a distribution of sizes, although it is not intended to foreclose the use of a single sized particle or particulate, provided the size is large enough as described above.

Dried bottom-surface-providing layer coating weights are typically between about 2 to about 30 g/m². Preferred coating weights are between about 5 and about 20 g/m².

Typically particles added to coatings for layer do not have a uniform size, but rather are defined in terms of a particle size distribution with an average particle size. Therefore it is preferred that p average>d where p average refers to average particle size and d refers to coating thickness.

Method of Coating the Temporary Carrier Web

Top-surface-providing layer 12 is coated directly onto a temporary carrier web 10 under the following processing conditions:

Type of coating: dip roll, meter roll, slot die (with or without vacuum), cross flow knife, notched bar, gravure, air knife

Web speed range: 3 to 100 and preferably 50 m/min

Coating weight range: 20 to 3,000 mg/ft² (215-33,000 mg/m²) and preferably 100 to 250 mg/ft²

Percent area of temporary carrier web covered: 10 to 99% and preferably 95%

Concentration of top-surface-providing layer range: 0.5 to 40% and preferably 1.0 to 3.0% (all weight percents)

Bottom-surface-providing layer 14 is then coated directly onto the top-surface-providing layer 12 under the following processing conditions:

Type of coating: dip roll, meter roll, slot die (with or without vacuum), cross flow knife, notched bar, gravure, air knife

Web speed range: 3 to 100 and preferably 50 m/min

Coating weight range: 20 to 3,000 mg/ft² (215-33,000 mg/m²) and preferably 1,500 to 2,000 mg/ft²

Percent area of layer covered: 10 to 99% and preferably 95%

Concentration of top-surface-providing layer range: 0.5 to 40% and preferably 5 to 15% (all weight percents)

Receiving Substrate

FIG. 2 shows a cross-sectional view of receptor media 20 of the present invention comprising a receiving substrate 22 having the bottom-surface-providing layer 14, from temporary carrier web 10, coated thereon and the top-surface-providing layer 12, also from temporary carrier web 10, coated on the bottom-surface-providing layer 14.

The receiving substrate can be any single layer or multilayer composite according to the requirements of image graphic usage. Most often, but not exclusively, the receiving substrate comprises a polymeric film backing coated on a major surface with pressure sensitive or hot melt adhesive which in turn is protected by a release liner. Alternatively, one can eliminate the polymeric film as the receiving substrate and use the present invention to transfer the receptor layer(s) onto an adhesive directly, protected by a release liner, provided that the resulting laminate of receptor/adhesive/liner has sufficient structural integrity that a polymeric film is not needed.

Nonlimiting examples of receiving substrates include naturally and synthetically-modified cellulosics, polyvinyl chlorides. solid and microvoided polyesters, polyolefins, polycarbonates, polyacrylates, polyacrylate esters, and copolymers thereof, including ionomers (e.g., Surlyn™ brand ionomer from DuPont of Wilmington, Del., USA). Examples of modified-polyolefins suitable for use in the present invention are disclosed in U.S. Pat. No. 5,721,086 (Emslander et al.) and copending, coassigned, U.S. patent application Ser. No.______ (Emslander et al.) (Docket No. 54323USA6A), the disclosures of which are incorporated by reference herein.

Polymeric films that are normally difficult to process for either chemical or mechanical limitations, can be easily transformed into an excellent receptor media of the present invention.

Useful receiving substrates can be either solid films or porous membranes depending on the desired ultimate usage of the image graphic.

Useful receiving substrates can be transparent, translucent, or opaque.

Useful receiving substrates can be adhesive-backed, fastener-backed, or neither. In FIG. 2, a layer of adhesive 24 with a protective release liner 26 is shown.

Preferably the receiving substrate has been treated with a corona discharge to promote adhesion of the receptor coating after transfer to the receiving substrate. A range of 0.5J/cm² to 2J/cm² has been found to be useful for adhesion promotion at a web speed of 15 meters per minute, with a preferred range of 1.0 J/cm² to 1.5 J/cm². Higher corona discharges were found to discolor some films and in some cases alter the mechanical properties of those films such as cause a reduction of tensile strength. In general, lower corona levels than 0.5 J/cm² did not improve adhesion. However, specific corona requirements may be governed by the nature of the receiving substrate.

Nonlimiting examples of such adhesive can be any conventional pressure sensitive adhesive that adheres to both receiving substrate 22 and to the surface of the item upon which the image graphic is destined to be placed. Pressure sensitive adhesives are generally described in Satas, Ed., Handbook of Pressure Sensitive Adhesives 2nd Ed. (Von Nostrand Reinhold 1989), the disclosure of which is incorporated by reference. Pressure sensitive adhesives are commercially available from a number of sources. Particularly preferred are acrylate pressure sensitive adhesives commercially available from Minnesota Mining and Manufacturing Company of St. Paul, Minn. and generally described in U.S. Pat. Nos. 2,973,826; Re 24,906; Re 33,353; 3,389,827; 4,112,213; 4,310,509; 4,323,557; 4,732,808; 4,917,928; 4,917,929; 5,141,790; 4,605,592; 5,045,386; 5,229,207; 5,296,277; and 5,670,557, and EPO Patent Publications EP 0 051 935 and EP 0 570 515 B1, and those adhesives disclosed in copending, coassigned, U.S. patent application Ser. No. 08/775,844 (Sher et al.) (all of which are incorporated herein by reference).

Release liners to protect the adhesive before usage are also well known and commercially available from a number of sources. Nonlimiting examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as defined in U.S. Pat. Nos. 3,957,724; 4,567,073; 4,313,988; 3,997,702; 4,614,667; 5,202,190; and 5,290,615; the disclosures of which are incorporated by reference herein and those liners commecially available as Polyslik brand liners from Rexam Release of Oakbrook, Ill., USA and EXHERE brand liners from P. H. Glatfelter Company of Spring Grove, Pa., USA.

Mechanical fastening elements can reside on an opposing surface to imaging, such as those disclosed in copending, coassigned, U.S. patent application Ser. No. 08/930,957 (Loncar), the disclosure of which is incorporated herein by reference.

Alternatively, the receiving substrate can be an adhesive layer protected by a release liner on one major surface. Nonlimiting examples of adhesives serving as the receiving substrate include any conventional pressure sensitive adhesive such as disclosed in Satas, Ed., Handbook of Pressure Sensitive Adhesives 2nd Ed. (Von Nostrand Reinhold 1989), the disclosure of which is incorporated by reference. Pressure sensitive adhesives are commercially available from a number of sources. Particularly preferred are acrylate pressure sensitive adhesives commercially available from Minnesota Mining and Manufacturing Company of St. Paul, Minn. and generally described in U.S. Pat. Nos. 2,973,826; Re 24,906; Re 33,353; 3,389,827; 4,112,213; 4,310,509; 4,323,557; 4,732,808; 4,917,928; 4,917,929; 5,141,790; 4,605,592; 5,045,386; 5,229,207; 5,296,277; and 5,670,557, and EPO Patent Publications EP 0 051 935 and EP 0 570 515 B1, and those adhesives disclosed in copending, coassigned, U.S. patent application Ser. No. 08/775,844 (Sher et al.) (all of which are incorporated herein by reference). Thus, with the proper adhesive composition providing its own internal integrity and opacity, one can eliminate the need for a polymeric film or membrane. Preferably, examples of sturdy adhesives include PSA's, hot melts and microspheres. If these adhesives are either transparent or translucent, colorants, such asTiO₂ particles, can be added to the adhesive to produce the desired translucency or opacity, respectively.

Method of Transferring the Top-Surface-Providing and Bottom-Surface-Providing Layers

The transfer of top-surface-providing layer 12 and bottom-surface-providing layer 14 from temporary carrier web 10 to receiving substrate 22 is facile and inexpensive generally under the following conditions:

Temperature: 30 to 160 and preferably about 110° C.

Pressure: 700 to 2500 and preferably about 1500 kPa

Transfer Speed: 10 to 50 and preferably about 15 m/min

Transfer methods can be a batch or continuous process, can involve other processing steps such as adhesive coating on the opposing major surface of the receiving substrate, and the like, without departing from the scope of the present invention.

Usefulness of the Invention

The ability to independently select the properties of a receiving substrate from the properties of the top-surface providing layer and the bottom-surface-providing layer is a significant feature of the present invention and opens up the possible materials that can be chosen as ink jet receptor media. The combination of the receiving substrate, carrier, and the receptor surfaces top-surface-providing layer and the bottom-surface-providing layer becomes an excellent receptor media for ink jet imaging.

The formation of receptor surfaces on a temporary carrier web and then transfer to a receiving substrate that itself is not suitable for initial coating or is too expensive to be held in inventory is also applicable to other types of image graphics media, to wit: electrostatic transfer media, electrostatic direct print media, piezo ink jet media, and the like.

The formation of receptor surfaces on a temporary carrier web and then transfer to a receiving substrate that itself is not suitable for initial coating or is too expensive to be held in inventory is also applicable to other types of sheet goods such as adhesive media, dirt resistant media, and conformable media.

### Examples

A. Preparation of Layers on Temporary Carrier Webs

1. A solution to make top-surface-providing layer was made up as follows:

2. The solution used was similar to that described in Example 1 of U.S. Pat. No. 5,747,148 (Warner et al.) except that it was more dilute and was composed of 67% by weight (of the total mixture) deionized water, 0.84% by weight Airvol 540 poly (vinyl alcohol) (available from Air Products), 31% denatured alcohol, 0.31% by weight of LOK-SIZE® 30 Cationic corn starch (available from A. E. Staley Manufacturing Company), 0.14% by weight of Xanthan gum, a polysaccharide gum known as Keltrol TF 1000 (available from Kelco division of Merck & Co. Inc.), and 0.15% by weight of Triton X-100 surfactant (available from Union Carbide Chemicals and Plastics Company Inc.). Alternatively, a variety of methods for homogenization of the corn starch may be used such as high speed Daymax mixer or commercial in-line homogenizers.

3. A solution to make bottom-surface-providing layer was prepared as a premix as described by U.S. Pat. No. 5,747,148 (Warner et al.), Example 3, paragraph 1 (before ammonia addition). To this premix was added 0.22% by weight of the premix solution of 7% aqueous ammonia. Shortly before coating, Xama 7 (available from Hoechst Celanese Corporation) and Triton X-100 surfactant (available from Union Carbide Chemicals and Plastics Company Inc.) were added to the coating solution. Then 59 ml of Xama 7 crosslinker per 100 lb (45.36 kg) of coating solution were added and mixed at low speed for ten minutes (no vortex). and 45 ml of Triton X-100 per 100 lb (45.36 kg) of coating solution added and mixed for 15 minutes under low speeds (no vortex).

4. Coating of the Temporary carrier web:

The intermediate was prepared by coating a 3.8 mil unprimed polyester film with the solution for top-surface-providing layer first and then the solution for the bottom-surface-providing layer prepared as described above. The solution for the top-surface-providing layer was applied to the web with a slot dye and metered off using a reverse meter roll giving a dry coating weight of 0.05 g/ft² (0.54 grams per square meter) (2-mil gap or 51 microns gap). The solution for the bottom-surface-providing layer was coated in tandem over the dried top-surface-providing layer using the same technique giving a dry coating weight of 1.6 g/ft² (17 grams per square meter) (5-mil gap or 127 microns). Metering speeds were matched 100% to the coating speeds (100 fpm). Each coating was conveyed at 100 fpm through four consecutive 40 foot ovens where the temperatures were 200, 220, 230, 260 C, respectively.

B. Lamination Equipment

Transfer was carried out in a nip between a lower heated steel roll (hot can) 18 inches in diameter and an unheated upper rubber-coated roll (durometer=80 on the Shore A scale). The upper roll was lowered onto and pressed against the lower roll by means of two hydraulic rams of 5 inches (12.7 cm) in diameter fed by an oil hydraulic line of adjustable line pressure from zero to 500 psi (zero to 3450 kPa).

C. Lamination to Desired Receiving Substrate

1. Transfer of the bottom-surface-providing layer and the top-surface-providing layer was carried out onto a 3550 vinyl film (available from 3M Commercial Graphics Division, 3M Center, Maplewood, Minn. 55144-1000). The 3550 film had been previously corona treated at 2.5KW (1.75J/cm²).

2. Line pressure was set at 350 PSI (2,400 kPa) applying a force of 6,900 lb (30,700N) to each end of the rubber roll, total force 13,780 lb (95,000N). Web speed was at 15 m/min (50 feet per minute).

3. Using prescribed conditions, the temporary carrier web having the two layers to be transferred was laminated to Scotchcal™ 3550 vinyl film.

4. At the winder, the intermediate carrier was separated from the receptor-coated Scotchcal™ 3550 film and the two substrates wound onto separate winders.

5. The receiving substrate (Scotchcal™ 3550 film previously not ink jet receptive) was now ink jet receptive and the PET carrier could be reused in preparation of the intermediate temporary carrier web with transferring layers.

The resulting ink jet receptive 3550 film was printed on an Encad Novajet III fitted with American Inks (available from American Ink Jet Corporation, 13, Alexander Road, Billerica, Mass. 01821).

A control example, (hand-coated onto 3550 film as described in U.S. Pat. No. 5,747,148 Example 3 but with the formulations and coating weights described in this Example), was printed on an Encad Novajet III fitted with American Inks (available from American Ink Jet Corporation, 13, Alexander Road, Billerica, Mass. 01821).

Test patterns were printed with very similar printed results in terms of bleed and solid fill continuity. Both the transferred receptor and the control gave excellent results in these regards. Color was also very acceptable on both samples and similar by eye. Color measurements are given below. Color measurements were done on a Gretag SPM-50 (set up as follows: 2° observer angle, D65, ANSI T, no filter, Abs). Table 1 shows the results.

TABLE 1

| | Control | | | | Transferred | | | | |
|---|---|---|---|---|---|---|---|---|---|
| | L* | a* | b* | C* | L* | a* | b* | C* | ΔE |
| Cyan | 42.06 | −20.03 | −42.97 | 47.4 | 41.88 | −24.28 | −43.59 | 49.9 | 4.3 |
| Magenta | 38.92 | 71.06 | −3.74 | 71.2 | 37.86 | 74.15 | −5.01 | 74.3 | 3.5 |
| Yellow | 84.70 | −7.28 | 87.87 | 88.2 | 85.18 | −7.80 | 89.40 | 89.7 | 1.7 |
| Black | 14.38 | 2.64 | 0.88 | 2.8 | 6.76 | 1.38 | 0.30 | 1.4 | 7.7 |
| Red | 38.92 | 63.54 | 33.5 | 71.8 | 37.28 | 64.81 | 35.07 | 73.7 | 2.6 |
| Green | 35.11 | −54.33 | 13.38 | 56.0 | 35.21 | −65.08 | 14.71 | 66.7 | 10.8 |
| Blue | 17.82 | 21.90 | −32.58 | 39.3 | 12.75 | 27.24 | −40.09 | 48.5 | 10.5 |

Table 1 shows that while there are some differences in color, they remain similar with good colors and color saturations in both the control and the transferred example. In fact color saturations (C*) tend to be a little higher in transferred example. The Control was made by hand-coating, a labor intensive and costly means of making an ink jet receptor.

Application of 3M 610 tape (available from 3M) to both imaged and unimaged areas, and then pulling off, failed to remove any of the coating or coating layers from the 3550 vinyl film, showing the coating had good adhesion to the vinyl as desired.

The invention is not limited to above embodiments. The claims follow.

What is claimed is:

1. An ink jet receptor on a temporary carrier web comprising:
one or more layers where one layer is a top-surface-providing layer is weakly bonded to the temporary carrier web.

2. The receptor according to claim 1, further comprising a bottom-surface-providing layer contacting the top-surface-providing layer.

3. The receptor of claim 2, further comprising intermediate layers between the top-surface-providing layer and the bottom-surface-providing layer.

4. The receptor of claim 2, wherein the temporary carrier web is selected from the group consisting of coated and uncoated paper liners, paper laminates, and plastic films.

5. The receptor of claim 2, wherein the top-surface-providing layer is releasable from the temporary carrier web and wherein the bottom-surface-providing layer is attachable to a receiving substrate.

6. The receptor of claim 2, wherein the top-surface-providing layer is a composition selected from the group consisting of poly(vinyl pyrrolidone), copolymers of vinyl pyrrolidone, poly(vinyl alcohol), polyacrylic acids, polymethacrylic acids or (1-alkyl) acrylic acid copolymers and the inorganic salts such as alkali metal salts derived therefrom, poly(alkylene oxides) or polyglycols, carbohydrates, alkyl and hydroxylalkyl cellulose derivatives, starch and starch derivatives such as hydroxyalkyl starches, carboxyalkyl celluloses and their salts, gum arabic, xanthan gum, carageenan gum, proteins and polypeptides.

7. The receptor of claim 2, wherein the bottom-surface-providing layer is a composition selected from the group consisting of poly(vinyl pyrrolidone), copolymers of vinyl pyrrolidone, poly(vinyl alcohol), polyacrylic acids, polymethacrylic acids or (1-alkyl) acrylic acid copolymers and the inorganic salts such as alkali metal salts derived therefrom, poly(alkylene oxides) or polyglycols, carbohydrates, alkyl and hydroxylalkyl cellulose derivatives, starch and starch derivatives such as hydroxyalkyl starches, carboxyalkyl celluloses and their salts, gum arabic, xanthan gum, carageenan gum, proteins and polypeptides.

8. The receptor of claim 2, wherein the top-surface-providing layer also includes particles and particulates.

9. The receptor of claim 2, wherein the bottom-surface-providing layer also includes particles and particulates.

10. The receptor of claim 8, wherein the bottom-surface-providing layer also includes particles and particulates.

11. A method for making an ink jet receptor media comprising the steps of:
(a) coating a top-surface-providing layer onto a temporary carrier web to form a layer or laminate of layers having a bottom surface and a top surface;
(b) contacting the bottom surface of the layer to a receiving substrate; and
(c) removing the temporary carrier web to reveal an ink jet ink receptor layer on the receiving substrate with the top surface of the layer as an exposed surface on the receiving substrate.

12. The method of claim 11, further comprising a step between steps (a) and (b) of coating a bottom-surface-providing layer on the top-surface- providing layer to provide the bottom surface.

13. The method of claim 12, wherein the contacting step comprises use of heat, pressure, an activation fluid, or a combination of them.

14. The method of claim 11, wherein the receiving substrate is selected from the group consisting of an adhesive layer, naturally and synthetically-modified cellulosics, polyvinyl chlorides, solid and microvoided polyesters, polyolefins, polycarbonates, polyacrylates, polyacrylate esters, and copolymers thereof.

15. The method of claim 11, wherein receiving substrate is coated with an adhesive on a surface opposite a surface where contacting step (b) occurs.

16. The method of claim 11, wherein the transfer step (c) occurs at a temperature of from about 30 to about 160° C., at a pressure of from about 700 to about 2500 kPa, and at a transfer speed of from about 10 to about 50 m/min.

17. The method of claim 16, wherein the transfer step (c) occurs at a temperature of about 110° C., at a pressure of about 1500 kPa, and at a transfer speed of about 15 m/min.

18. The method of claim 11, wherein coating step (a) occurs at a web speed of from about 3 to about 100 m/min; at a coating weight of from about 215 to about 33,000 mg/m²; covering from about 10 to about 99 percent of the area of the temporary carrier web; and at a concentration of from about 0.5 weight percent to about 40 weight percent.

19. The method of claim 12, wherein the coating step for the bottom-surface layer occurs at a web speed of from about 3 to about 100 m/min; at a coating weight of from about 215 to about 33,000 mg/m²; and covering from about 10 to about 99 percent of the area of the temporary carrier web.

20. The method of claim 14, wherein the adhesive layer includes TiO₂ particles.
